(19) United States
(12) Patent Application Publication
(10) Pub. No.: US 2024/0326125 A1
(43) Pub. Date: Oct. 3, 2024

(54) Method of Manufacturing Porous Structures With Controllable and Directionally Tunable Porosity Via Freeze Casting

(71) Applicant: Carnegie Mellon University, Pittsburgh, PA (US)

(72) Inventors: O. Burak Ozdoganlar, Pittsburgh, PA (US); Rahul Panat, Pittsburgh, PA (US); Mert Arslanoglu, Pittsburgh, PA (US)

(73) Assignee: Carnegie Mellon University, Pittsburgh, PA (US)

(21) Appl. No.: 18/283,252

(22) PCT Filed: Mar. 31, 2022
(86) PCT No.: PCT/US2022/022916

§ 371 Date: Sep. 21, 2023

Related U.S. Application Data
(60) Provisional application No. 63/168,378, filed on Mar. 31, 2021.

(51) Int. Cl. B22F 3/11; B22F 1/107; B22F 3/22; B28B 1/00; B29C 39/02; B29C 39/38; B29C 39/44

(52) U.S. Cl. CPC B22F 3/1109; B22F 1/107; B22F 3/1115; B22F 3/1121; B22F 3/222; B28B 1/007; B29C 39/38; B22F 2203/11; B22F 2207/15; B29C 39/021; B29C 39/44

(57) ABSTRACT

A method of manufacturing a porous part includes controlled freeze casting of a slurry. After freezing, a solvent in the slurry is removed by sublimation and the remaining material is sintered to form the porous part. Spatial and temporal control of thermal conditions at the boundary and inside of the mold can be controlled to create parts with controlled porosity, including size, distribution, and directionality of the pores. Porous parts with near-net-shape from ceramics, metals, polymers and other materials and their combinations can be created.

### CROSS-REFERENCE TO RELATED APPLICATIONS

This application claims the benefit under 35 U.S.C. § 119 of U.S. Provisional Application Ser. No. 63/168,387, filed Mar. 31, 2021, which is incorporated herein by reference.

### STATEMENT REGARDING FEDERALLY SPONSORED RESEARCH

Not applicable.

### BACKGROUND OF THE INVENTION

The present disclosure is related generally to the manufacture of porous materials. More specifically, the disclosure is related to the manufacture of engineered materials with porosity characteristics adjusted by controlling the spatial and temporal thermal profile of a freeze casting process.

Porous materials have many advantageous properties, including a high surface-to-volume ratio, high specific strength under compression, directional permeability, and tailored thermal properties. As a result, engineered materials with defined internal porosities are utilized in many different applications, including their use as lightweight components in the aerospace industry, catalytic converters, energy storage and conversion devices (i.e. fuel cells, batteries, turbines, etc.), thermal control systems, scaffolds for tissue growth, and many others.

Commonly, porous parts have a porosity with uniform size and shape distribution throughout their three-dimensional geometry. In addition to controlling average pore size and distribution, unique advantages could be realized if the overall directionality of the pores is dictated. That is if the pore orientation can be dictated along a favorable direction (e.g., elongated holes). For example, this directionality can be used to flow one type of fluid (gaseous or liquid) in a particular direction, or create electrical/thermal/ionic connectivity with a preferred directionality. Similarly, a meandered pore orientation significantly increases the tortuosity to enhance the performance of chemical or electrochemical processes, e.g., in batteries and fuel cells, catalytic processes, water filtration, and desalination.

Several methods have been developed to fabricate porous parts. The gas foaming process involves consecutive chemistry-driven foaming and polymerization steps. Although this method has been used broadly for industrial fabrication of polymer foams, such as expanded polystyrene, it poses challenges in creating directional open porosity necessary for certain applications. The inverse opal and template-assisted self-assembly methods are used to fabricate porous parts with highly ordered uniform spherical pores. However, the need for using monodispersed microsphere lattices that form the pores and complex chemical processes to remove the sacrificial microspheres limits the use of these processes to only a few material systems. In addition, parts created with these techniques may exhibit a high percentage of closed pores, hindering their utilization for various important applications. The partial sintering process involves using agglomerated fine powders, where compaction pressure is used to vary the pore size. However, the pore geometry depends on particle sizes, and the channel formation is random. Although useful for some applications, these methods offer limited controllability of pore geometries and connectivity. And none of the aforementioned methods can control the overall directionality/orientation of the pores in a fabricated sample. Lastly, these methods generally cannot create near-net-shape components with controlled porosity.

Freeze casting is another process for making porous materials, where the porosity is created by directional solidification of liquid in a well-dispersed slurry, followed by low-pressure drying (or solvent evaporation) to remove ice crystals, and high-temperature heat treatment to sinter the remaining solid particles. Within the context of the freeze casting process, “ice” refers to the solid form of the solvent, which could be water, camphene, or another solvent. Current processes rely on either axial or radial freezing to create porosities. The current freeze casting process is capable of creating porous parts, but the porosity characteristics lack control and reproducibility. Furthermore, controllable directionality of pores within the porous part has not been demonstrated.

Therefore, it would be advantageous to develop a manufacturing process that can control the internal porosity of the engineered structures, including pore size, distribution, shape, and directionality. Similarly, fabricating porous near-net-shape porous parts can bring considerable time and cost savings. The lack of these abilities to date have limited the use of porous components, whether they are ceramics, metals, polymers, or composites.

### BRIEF SUMMARY

According to embodiments of the present disclosure is a method of manufacturing porous structures with a controlled internal porosity by controlling the spatial (three-dimensional) and temporal (in time) thermal profile during freezing. The internal porosity control includes not only size, shape, and distribution of holes, but also overall directionality (e.g., elongation in a preferred direction) of the pores. Such porosity can be realized in near-net-shape components, or components that are manufactured to a size and shape near to the final product. The structural form of the ice depends on the thermal conditions during freezing—the geometry of the ice dictates the geometry of the pores in the final porous structure. Thermal control can be accomplished passively by designing thermal boundary conditions, or actively and dynamically (temporally) using heaters and/or coolers that are placed on the boundaries or inside the slurry to control the solidification of a slurry during the freeze casting process. Similarly and uniquely, active and dynamic change in thermal conditions can be imposed by using light-based methods, such as lasers or high-power light-emitted diodes (LEDs) that can selectively heat certain portions of a reservoir holding the slurry, changing the freezing behavior selectively within the structure. Similarly, other forms of energy (e.g., ultrasound) could be used to control local temperatures in a time-dependent manner within the sample.

The reservoir may comprise a mold having the final shape of the part, enabling creation of a near-net-shape part. In addition to controlling the shape of the freeze front, the process can be used to control the freeze front velocity, both of which can be used to adjust the size, shape, orientation, and distribution of the porosity. In addition to having capability to create near-net-shape parts, final part shape can be created after freeze casting by using removal processes (machining, grinding, laser, etc.) in the green state (before sintering) or after sintering as the final step. Solid loading of the slurry, particle size, cooling temperature, and distance from cooling/heating surfaces comprise process parameters that can be adjusted to affect the final porosity of the part. Multiple types, sizes, and shapes of the solid particles can be used to increase controlling not only overall but also micro/nano porosity.

### BRIEF DESCRIPTION OF THE SEVERAL VIEWS OF THE DRAWINGS

FIG. 1 is a flowchart of the process according to one embodiment.

FIG. 2A is a temperature chart showing the processing steps relative to the melting point of a solvent.

FIG. 2B is an image of a porous part.

FIGS. 3A-3C shows systems used to freeze and/or selectively heat the slurry.

FIGS. 4A-4D are images and graphs showing characterization of porosity.

FIGS. 5A-5B are graphs and images showing pore orientation and freeze front location within different porous parts.

FIGS. 6A-6B are graphs showing pore orientation at different heights in a porous part.

FIG. 7 is an example of a porous part with a non-uniform controlled porosity.

FIG. 8 is an example of a light-based heater used to control a thermal gradient.

FIG. 9 depicts a porous part created from a controlled freeze front.

### DETAILED DESCRIPTION

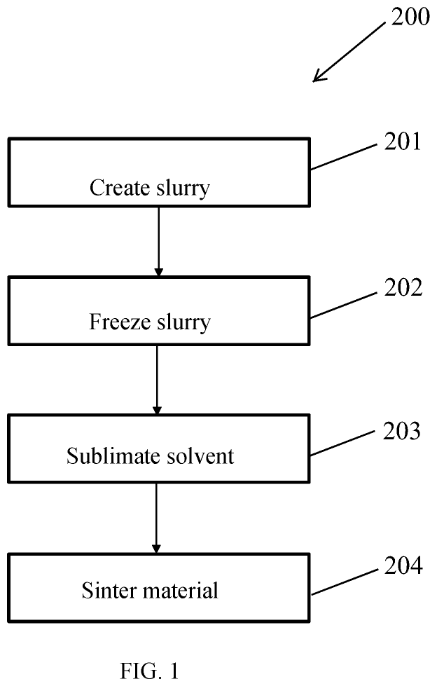

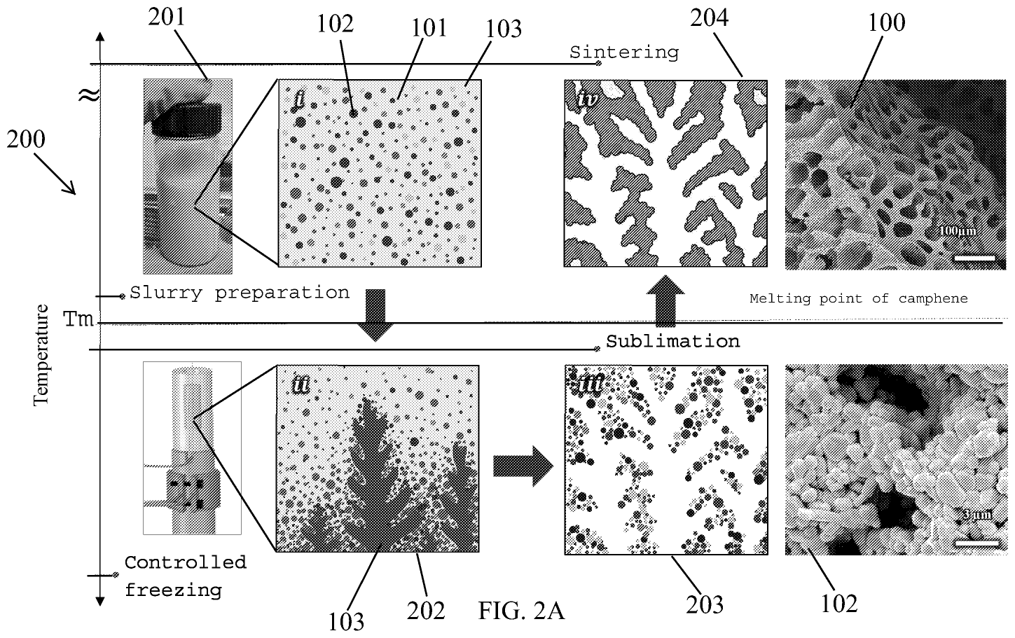

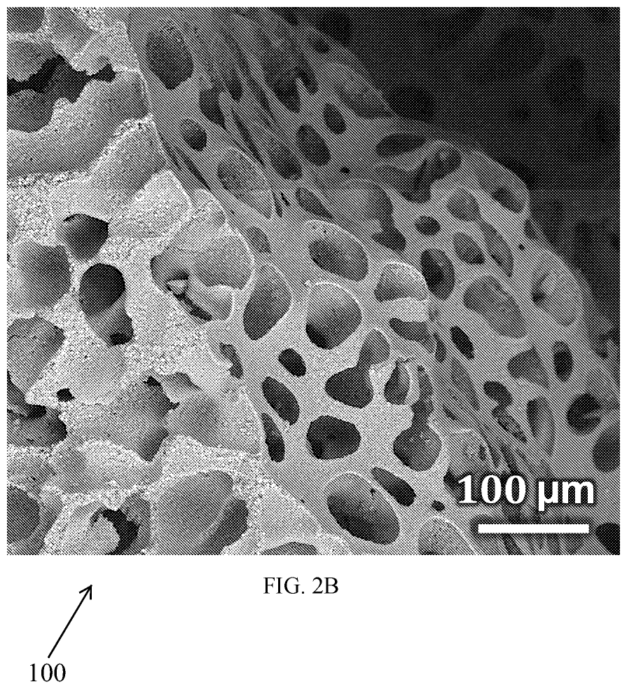

According to embodiments of the disclosure is a method of manufacturing a porous part 100 with an interconnected internal porosity via a freeze casting process 200. The process 200 utilizes highly anisotropic solidification characteristics of liquids to create structures with controlled porosity from colloidal suspensions. As shown in FIG. 1, the freeze casting process 200 comprises the following steps: step 201—a slurry 101 is made by dispersing a powdered material 102 in a liquid solvent 103; step 202—the slurry is filled in a mold 301 and frozen by carefully controlling the thermal gradients; step 203—the frozen solvent 103 is sublimated, dried, evaporated, or otherwise removed from the slurry 101; and step 204—the material 102 remaining in the mold 301 after the solvent 103 is removed is sintered to create the porous part 100. FIG. 2A is a chart showing the processing steps 201-204 for the unidirectional freeze casting of a slurry 101 relative to the melting point of the solvent 103, with steps 202 and 203 occurring below the melting point of the solvent 103.

In this example embodiment, the slurry 101 used in step 201 comprises silica (SiO₂), having a particle diameter of 400 nm to 2 μm, as the powdered material 102 and camphene (C₁₀H₁₆), a non-polar solvent with a melting temperature of 46° C.-52° C., as the solvent 103. While this example embodiment utilizes silica and camphene, other materials can be used depending on the intended application for the porous part 100. For example, water or tert-butyl alcohol as the solvent 103; alumina, hydroxyapatite, nickel, titanium, or polymers as the powdered material 102 can be used. Optionally, surfactants, such as Hypermer KD-23 anionic dispersant, can be added, at a given percentage (e.g., 2.5 wt. % of the solid material 102 in the example embodiment), to lower the slurry 101 viscosity and produce a stable suspension by preventing aggregation of the particles of powdered material 102.

To form the slurry 101, the dispersant and liquid-phase (or molten) solvent 103 are premixed using a stirring/mixing system (e.g., a magnetic stirrer) at a controlled temperature (e.g., on a hot plate at 60° C.) for a certain amount of time (e.g., 1 h). The powdered solid phase material 102 (e.g., the silica powder) is pre-heated (e.g., to 60° C.) within a closed container and gradually added into the liquid medium to ensure uniform coverage of the dispersant on the particle surfaces to avoid agglomeration and settling. The mixture is kept mixing on the same hot plate for a sufficient duration to obtain a stable and well-mixed colloidal suspension.

During freezing at step 202, the formation of solidified ice structures is governed by the phase-change dynamics of the solvent 103 and the physical interaction between the advancing freeze front and the suspended particles 102 in the slurry 101. For instance, when the solvent 103 is water, the ice structures assume lamellar forms, whereas dendritic ice structures form when the solvent 103 is camphene. As those ice structures grow within the slurry 101, they repel and consolidate the solid particles 102. The shape, directionality, and distribution of the pores within the part 100 are dictated primarily by the ice structures and secondarily by the sintering profile. As shown in FIG. 2A, the dendric pore networks depicted in the scanning electron microscope micrographs arise from the freezing properties of the camphene solvent 103. FIG. 2B shows an enlarged view of the pore networks in the porous part 100.

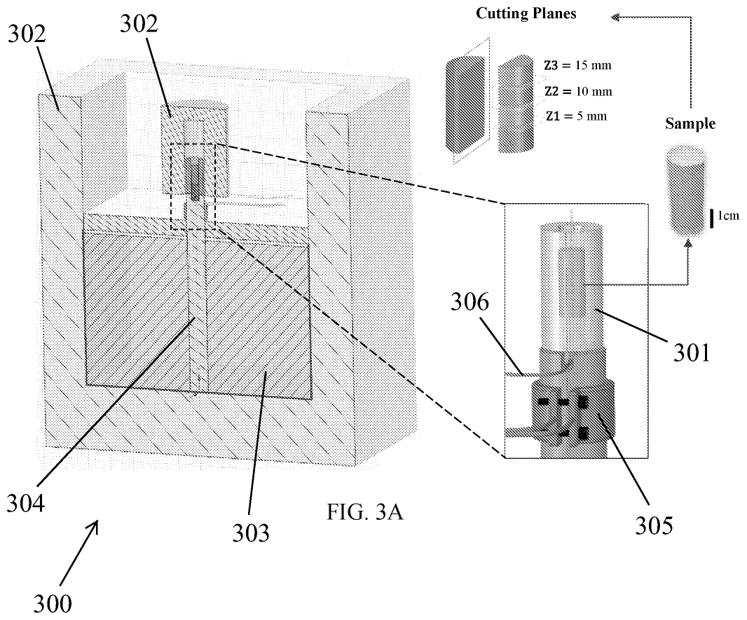

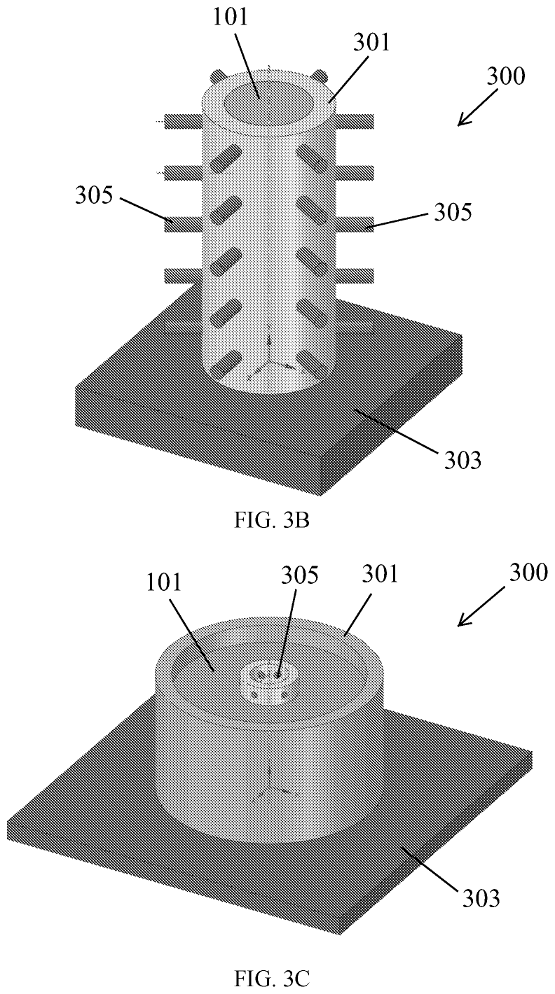

To complete freezing at step 202, the prepared slurry 101 is poured into a mold 301 (12 mm diameter, 40 mm height) that can be created by fitting a silicone rubber tube (10 mm wall thickness) around a copper insert (25 mm height), which blocks the bottom opening of the tube and acts as the cooling surface of the mold 301 (see FIG. 3A). The mold 301 is placed on top of a copper insert. A thermal paste (such as OT-201, Omega Engineering Inc.) is applied between the bottom of the copper insert and the top of a cold finger 304 to realize a thermally conductive interface. A cooling reservoir 303 is filled with an ethanol-dry ice mixture, which provides a cooling bath temperature of −40° C. Alternatively, the cooling can be controlled using a Peltier cooler, liquid nitrogen, recirculated chiller, etc., and any combinations thereof. Unidirectional freezing is realized by setting a base temperature (at the copper insert) of below the melting point of the solvent 103. In one example embodiment, the base temperature can be set at −5° C. or 20° C. Alternatively, instead of the base temperature, the cooling rate can be controlled (constant or variable).

Referring again to FIG. 3A, in this example embodiment, the freezing apparatus 300 used in the process 200 comprises a mold 301 containing the slurry 101, fiberglass (or other types of) insulation 302 that wraps around the mold 301, a cylindrical stainless steel cooling reservoir (i.e. cooler) 303, expanded polystyrene (EPS) thermal insulation 302 around the cooling reservoir 303, and a copper pole 304 that functions as a cold finger, connecting the cooler 303 to the mold 301. The cold finger 304 has a diameter of 40 mm and a height of 30 cm. A band heater 305 is wrapped around the upper end of the copper pole 304. A thermocouple 306 inserted into a copper insert at the base of the mold 301 at 10 mm below the slurry 101 is used for closed-loop control of the cold surface temperature using PID controller. For the pore-steering, an additional fiberglass insulation material or an aluminum housing can be placed on the outer sidewalls of the mold 301 to modify the heat transfer in the radial direction. FIG. 3B shows an alternative freezing apparatus 300, where a series of heaters 305 (i.e. a heater matrix) is positioned on the exterior of the mold 301. The heaters 305 can be selectively activated to control the freeze front within the slurry 101. FIG. 3C is yet another alternative embodiment of the freezing apparatus 300, where a series of heaters 305 are positioned on an interior portion of the mold 301.

After the process of directional freezing at step 202, the frozen sample is removed from the silicone mold 301 and kept under a fume hood for a period of time (e.g., 24 hours) for the sublimation of the solvent 103. Note that the removal of the frozen solvent phase can be realized using different methods (e.g., chemical) and in different environments (e.g. in a vacuum with or without temperature control, or in an inert environment). During sublimation at step 203, removal of the solvent 103 can be confirmed by the weight measurements using a precision scale. The sublimation can be stopped after the complete removal of the solvent 103 is confirmed. After sublimation, at step 204 the “green” sample is sintered in a furnace (e.g., 1700 Rapid-Temp Series, CM Furnaces Inc.) under an argon (or nitrogen, or other inert gas) atmosphere to fuse the individual particles to create a porous silica part 100 with increased strength and structural integrity. In one example embodiment, the sintering profile includes a heating rate of 4° C./min to 700° C., followed by 1° C./min to 1275° C., and a 3 h dwell period at this temperature. The slower heating rate at higher temperatures can be used to prevent cracking of the part 100. The part 100 is then cooled down to room temperature with a maximum cooling rate of 5° C./min using an integrated chiller system to prevent cracks or other defects from forming.

### Porosity Characteristics

Images from scanning electron microscopy (SEM) can be used to characterize the porosity of the sintered parts 100. Alternatively, computer tomography (CT) scanning, mercury porosimetry, and other methods may be utilized for this purpose. For the SEM imaging, the parts 100 were cross-sectioned at predefined Z planes along the height of the sample (see FIG. 2A) using a low-speed diamond saw. Before sawing, the parts 100 are infiltrated with a low viscosity epoxy to prevent potential damage to the microstructure from sawing. After grinding and fine polishing with 1 μm and 0.3 μm alumina particles, the samples are sputtered with 2 nm platinum to avoid charging in the SEM.

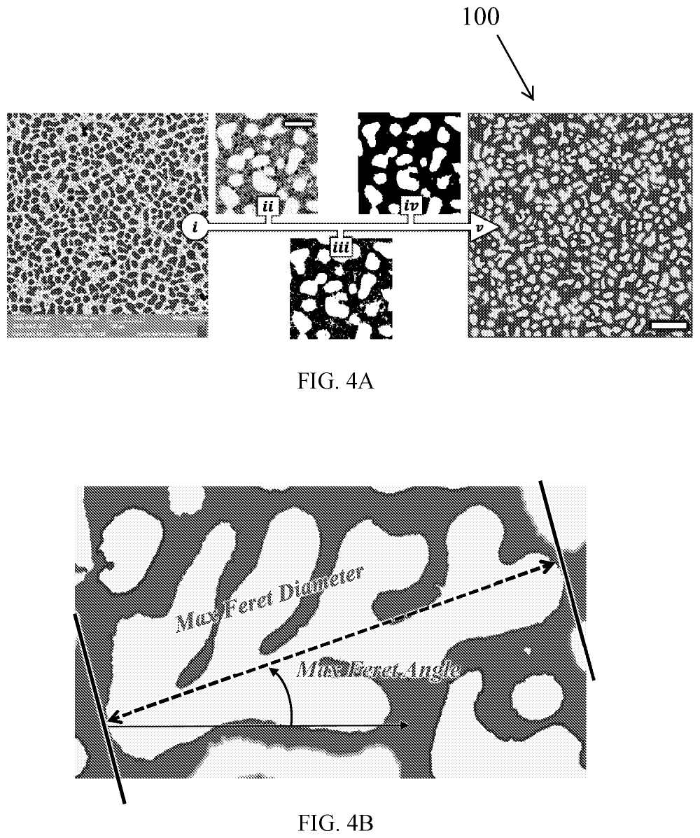

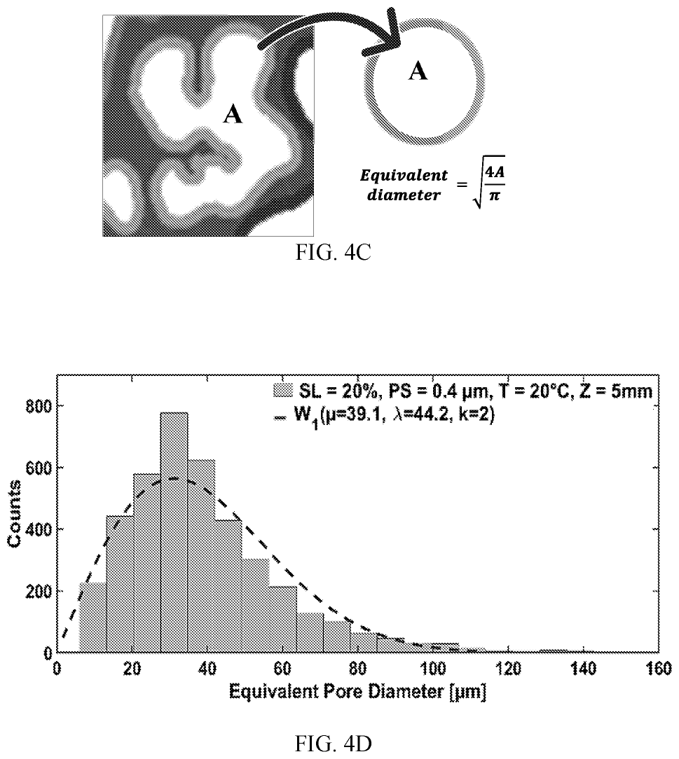

FIGS. 4A-4D show characterization of the porosity of the sample. The parameters used to characterize the porosity include: (1) areal porosity, the ratio of the total white area to the overall SEM image area; (2) equivalent pore diameter, the diameter of a circle with the same enclosed area as the pore; (3) maximum Feret diameter, the maximum distance between two parallel planes tangent to the boundary of a pore (this measure indicates the shape of the pores); (4) maximum Feret angle, the angle of the maximum Feret diameter from the horizontal plane (this measure shows the overall directionality of the pores); and (5) shape factor, the ratio of the maximum Feret diameter to the equivalent pore diameter.

FIG. 4A summarizes the image processing steps. As shown in FIG. 4A, the image colors in the raw cross-sectional SEM image are inverted to redefine the pores as (bright) objects. The image is then converted into a binary mask using an adaptive local median filter for more accurate segmentation. Next, impurities and SEM artifacts are eliminated from the image by using consecutive erosion and morphing techniques. During this step, the scale bar of each SEM image is used to calculate the pixel dimensions (μm/pixel), which determines the dimensional accuracy of the extracted features, i.e., smallest detectable pore size. Since the size of smaller pores in some of the SEM images is comparable to that of these impurities, an additional inspection to differentiate pores from impurities led to an improvement in detection accuracy. In the last step, each pore is identified using edge detection.

After image processing, tabular statistical data and histograms with appropriate continuous distribution fits are stored for each image, as shown in FIG. 4D. The number of bins for each histogram was calculated by rounding up the square root of the number of elements in the corresponding data. A 2-parameter Weibull distribution was chosen to represent the statistical distribution of the porosity parameters. Weibull distribution has been applied to describe particle size distributions. Additionally, the mean value of each data distribution was calculated and utilized as an additional metric.

The analysis depicted in FIGS. 4A-4D can be used to determine the effects of input parameters on the process outputs. The input parameters included solid loading (SL), particle size (PS), cooling temperature (T, measured by a thermocouple in the copper insert at the bottom of the slurry), and the distance/height (Z) from the cooling surface. The output metrics of areal porosity, pore size, pore shape, and pore orientation are analyzed.

### Controlling the Directionality of the Pores: Pore Steering

Controlling the spatial and temporal thermal profile during freezing at step 202 can accomplish “pore steering,” i.e., controlling the direction of porosity. The freeze casting process 200 can be used to steer the pore orientation via modification of the thermal boundary conditions. A secondary cooling boundary, such as from the periphery of the mold 301, will cause a significant change in pore orientation, inclining the pores towards the axis of the mold 301. In other embodiments, pore steering can be accomplished by varying the rate of cooling or heating at certain locations in the slurry 101 during the freezing process. For example, one side of the mold 301 may be selectively heated then cooled, allowing the slurry 101 to go through multiple freeze/thaw cycles.

For demonstration, in one example embodiment, to accomplish pore steering with bidirectional cooling, an axisymmetric, thermally conductive housing is prepared by combining an aluminum pipe with 1 mm wall thickness with aluminum foil and copper tape. The housing is tightly fitted around the silicone mold 301. In this arrangement, the connection of the housing with the copper insert at the bottom of the mold 301 forms a second cooling source for the mold 301. An additional thermocouple can be placed in the aluminum housing to monitor the side-surface temperature. The maximum Feret angle was utilized to assess pore orientation. Table 1 identifies parameters and levels used in different pore steering set-ups.

TABLE 1

| Design Factor | Low | | High | | *Mid |
|---|---|---|---|---|---|
| SL (Solid Loading %) | 20% | | 40% | | 30% |
| PS (Particle Size) | 0.4 | μm | 2 | μm | — |
| T (Cooling Temperature) | −5° | C. | 20° | C. | — |
| Z (Distance from Cooling Surface) | 5 | mm | 15 | mm | 10 mm |

In a range of porous ceramics applications, controlling the directionality of the pores, i.e., the orientation of pores along a direction, within a part 100 can be advantageous. For instance, a meandered pore orientation significantly increases the tortuosity to enhance the performance of chemical or electrochemical processes. Unidirectional freeze casting of camphene-based slurries 101 naturally produces pores and channels oriented normal (in the Z direction) to the freeze front. Modifying the thermal boundary conditions enables “steering” the pores to control the pore orientation within porous ceramic parts 100.

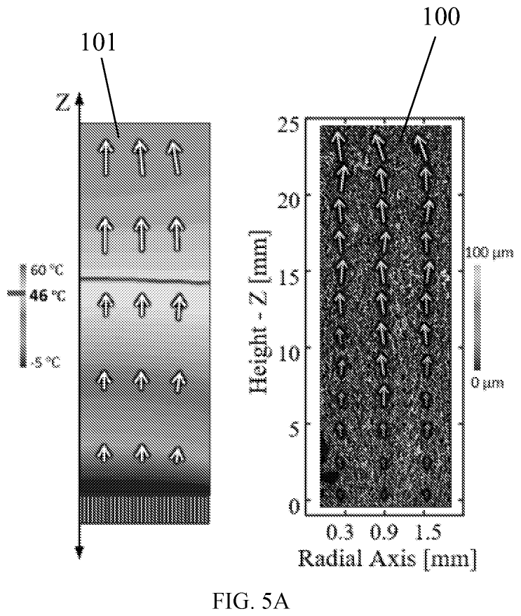

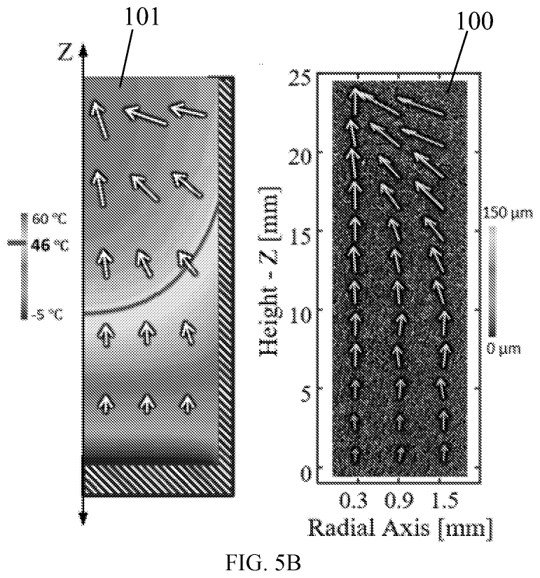

To guide the selection of boundary conditions for pore steering, the progression of the freeze front can be controlled by changing the thermal boundary conditions spatially and temporally (in time). For example, unidirectional (perfectly insulated side surface with cooling only in the Z-direction) and bidirectional (additional cooling on the side surfaces) cooling thermal boundaries produce different pore orientation. The latter includes cooling from the periphery of the cylinder and the bottom surface. Thermal gradients for these two conditions are given in FIGS. 5A-5B. The gradient map represents the temperature distribution, and the freeze front is indicated with the solid line within the sample at the selected instant. A set of vectors normal to the freeze front are also shown with arrows, where the size of each arrow is inversely proportional to the freeze-front velocity at that location. The elongation (maximum Feret diameter) of the pores is expected to be inversely proportional to the freeze-front velocity. Thus, the orientation and size of the arrows are expected to follow those of the pores.

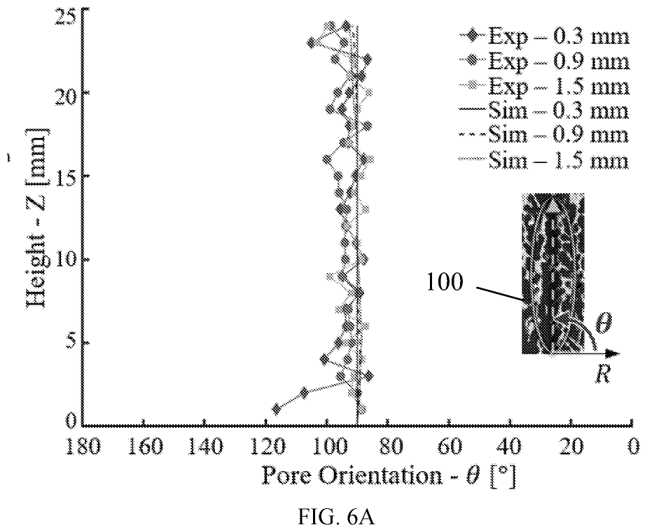

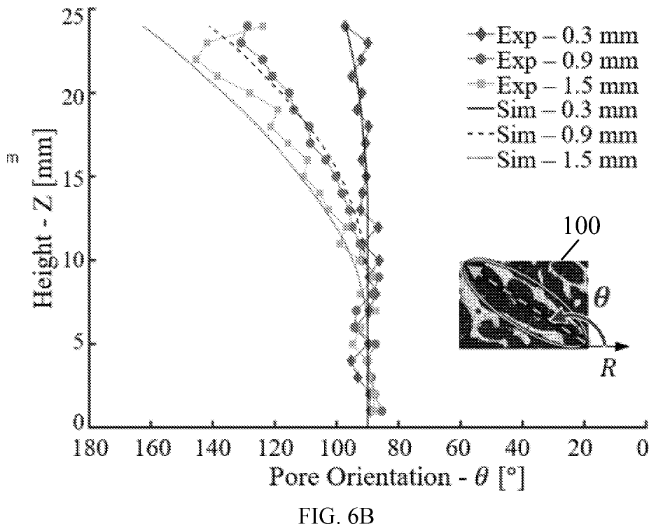

Pore orientations are shown in FIGS. 6A-6B. In unidirectional freezing, the horizontal freeze front is expected to move upwards, primarily in the vertical direction. Since the preferred dendrite growth direction is along the thermal gradients, the final part 100 has a porosity mainly oriented in the Z direction, as indicated by the vertical arrows in FIG. 5A. Furthermore, the pore elongation does not vary with the radial position (the R coordinate) in unidirectional freezing. On the other hand, in bidirectional freezing, the pore orientation is dependent on the radial position. At the center of the sample 100, the pores are oriented nearly vertically, similar to the case of unidirectional freezing. For heights greater than ˜7 mm, the pores are inclined towards the center at radial positions away from the center, where the inclination increases with increased radius. The additional cooling along the side surface of the mold induces a concave-shaped freeze front, causing an increasing inclination in pore orientation.

The thickness of the interfacial liquid film between the freeze front and the ceramic particles is inversely proportional to the freeze front velocity. Since the velocity decreases with height, especially for constant temperature cooling, the resultant thicker liquid film can transport more particles and clear the dendrite growth paths, enabling pores with increased elongation. In FIGS. 5A-5B and 6A-6B, the samples have the same input parameters (SL equals 20%, PS=2 μm, and T=−5° C.).

As shown in these figures, the freeze casting process 200 has the capability of steering the pore orientation via modification of the thermal boundary conditions. A secondary cooling boundary (from the periphery of the cylindrical mold 301) causes a significant change in pore orientation, inclining the pores towards the axis of the part 100.

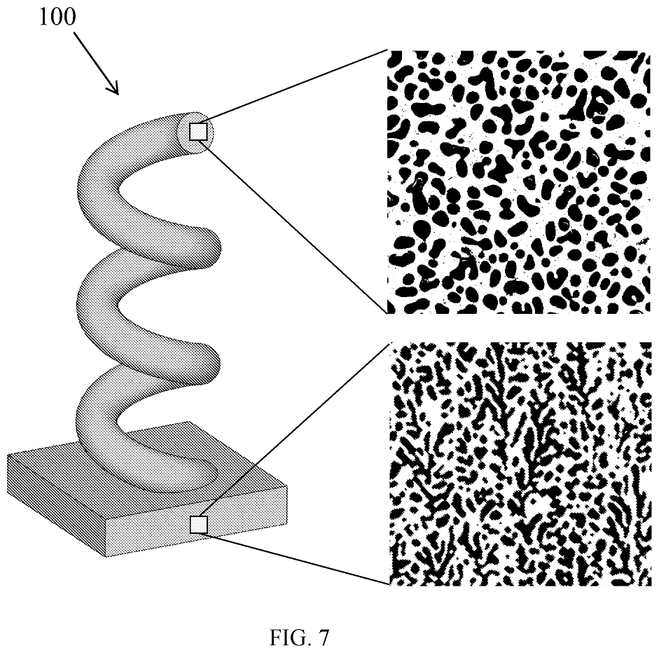

By controlling the thermal profile during the freezing step 202, porous parts 100 with non-uniform pore size and/or orientation can be created. FIG. 7 is an example of a porous part 100 having a complex geometry with a non-uniform controlled porosity. As shown in FIG. 7, the pore size and pore orientation differ at the bottom of the part 100 compared to the top of the part 100.

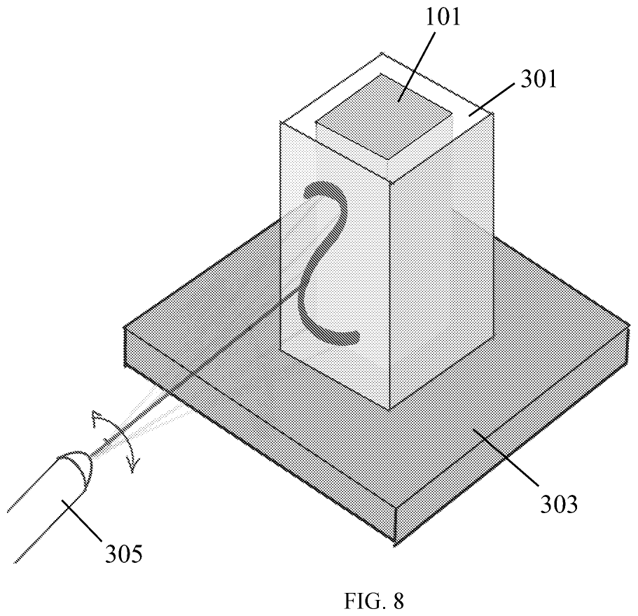

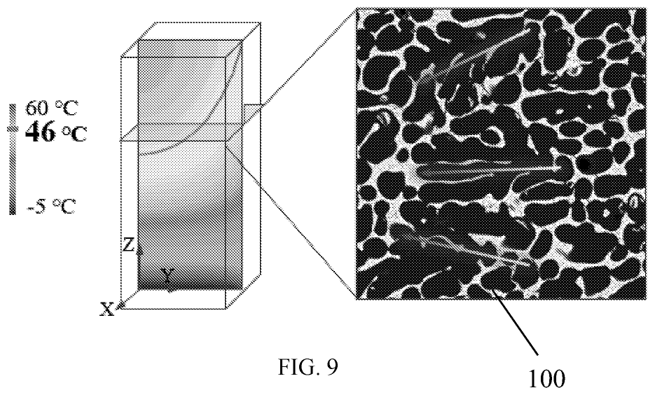

A variety of methods can be used to control the thermal profile. FIG. 8 is a laser-based heater 305 used to control the freeze front within the slurry 101. In this example, the mold 301 may be comprised of a material that is transparent to the laser, permitting the laser's energy to penetrate into the slurry 101. FIG. 9 is an example of a porous part 100 with pores aligned in a particular direction.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

1. A method of creating a porous part comprising:
forming a slurry by dispersing a powdered material in a solvent;
freezing the slurry in a mold,
wherein a thermal gradient within the slurry is controlled using at least one of a cooler, a heater, a light emitting device, and an ultrasonic device;
removing the solvent from the slurry to form a network of pores in spaces between the powdered material,
wherein the powdered material remains in the mold; and
sintering the material to form the porous part.

2. The method of claim 1, wherein the thermal gradient is controlled at a specific location within the slurry.

3. The method of claim 1, wherein the thermal gradient is controlled across the entirety of the slurry.

4. The method of claim 1, wherein the thermal gradient is controlled as a function of time.

5. The method of claim 4, wherein a freeze front propagates from a first end of the mold in contact with the cooler to a second end.

6. The method of claim 5, further comprising:
heating a portion of the slurry separated by a distance from the first end of the mold, wherein the heated portion causes a deviation in a path of the freeze front.

7. The method of claim 1, further comprising:
modifying a thermal boundary condition during freezing to modify a pore orientation of the porous part.

8. The method of claim 7, wherein the pore orientation is modified to form complex microchannels with constant or changing directionality.

9. The method of claim 1, wherein a thermal gradient within the slurry is controlled as a function of time as a freeze front propagates through the slurry.

10. The method of claim 1, wherein a thermal gradient within the slurry is controlled at a boundary of the slurry and the mold.

11. The method of claim 1, wherein the porous part has a near-net-shape.

12. The method of claim 1, wherein controlling the thermal boundary comprises using bidirectional cooling by cooling a side of the mold and a base of the mold.

13. The method of claim 12, further comprising forming a complex-shaped or concave-shaped freeze front.

14. The method of claim 1, wherein the powdered material comprises a metal.

15. The method of claim 1, wherein the powdered material comprises a ceramic.

16. The method of claim 1, wherein the powdered material comprises a polymer.

17. The method of claim 1, wherein the powdered material comprises an atomically thin two-dimensional material.

18. The method of claim 1, wherein the powdered material comprises a plurality of materials.

19. The method of claim 1, wherein the solvent is removed from the slurry via sublimation or evaporation.

20. The method of claim 1, wherein the cooler is placed in at least one of the following locations: at a boundary of the slurry and the mold, at an end of the mold, and within the slurry.
